(19) United States
(12) Patent Application Publication
(10) Pub. No.: US 2010/0044391 A1
(43) Pub. Date: Feb. 25, 2010

(54) ICE DISPENSER HAVING A SAFETY APPARATUS

(76) Inventors: Russell J. Fallon, Louisville, KY (US); Matthew William Davis, Prospect, KY (US); Richard DeVos, Goshen, KY (US); Jeffrey Mellinger, Louisville, KY (US); William Merritt Nall, Louisville, KY (US); Daniel S. Renz, Louisville, KY (US); Bipin Shaha, Mumbai (IN); Arun Madhav Talegaonkar, Louisville, KY (US)

Correspondence Address: General Electric Company;GE Global Patent Operation, PO Box 861, 2 Corporate Drive, Suite 648, Shelton, CT, 06484, US

(21) Appl. No.: 12/194,726

(22) Filed: Aug. 20, 2008

(51) Int. Cl. G07F 11/00; F25C 5/18; F25D 25/04

(52) U.S. Cl. 221/2; 62/344; 62/381

(57) ABSTRACT

An ice dispenser having a safety apparatus is disclosed. The ice dispenser includes a bin for storing ice to be dispensed; a chute in communication with the bin; a device for at least one of crushing the ice and moving the ice from the bin to the chute; a controller for activating the device in response to a dispensing signal; and a safety apparatus configured to determine a presence of an object in the chute and to provide an indication responsive to the determined presence to the controller. The controller deactivates the device after receiving the indication. A refrigerator incorporating such an ice dispenser is also disclosed.

### BACKGROUND OF THE INVENTION

The present invention relates generally to an ice dispenser. More particularly, the present invention relates to an ice dispenser having a safety apparatus.

Ice dispensers are known in the art. They can be used as stand-alone units or as part of home appliances such as refrigerators. Refrigerators often include a freezer compartment, and a fresh food compartment. The freezer compartment is used to store food and other items at temperatures below zero degrees Celsius while the fresh food compartment is used to store foods and other items at temperatures above zero degrees Celsius. Such refrigerators may also include a beverage service center disposed or installed in one of the compartment doors. The beverage service center often includes an ice dispenser, a cold-water dispenser, a hot-water dispenser, or a combination thereof.

The structure and operating principle of ice dispensers are well known in the art. An ice dispenser typically includes an ice storage receptacle or bin, a dispensing chute having an input end in flow communication with the ice storage bin and an opposite output or exit end, and a mechanically or electrically activated door, such as a solenoid-operated door, for regulating the flow of ice from the dispensing chute. When activated, the door permits the ice to move or flow under the force of gravity from the dispensing chute into a cup or the like positioned under the exit end of the dispensing chute. In one known approach, a signal for activating the solenoid is generated by the movement of a lever arm attached to a dispensing switch. More specifically, the signal is generated by the dispensing switch which is activated by the movement of the lever arm when a cup is placed and held against the lever arm. In another known approach, a user positions the cup beneath the exit end of the dispensing chute with one hand while depressing a dispensing switch with the other to generate the signal.

An auger is often disposed or arranged in the ice storage bin. The auger can be used for mixing the ice cubes periodically to prevent individual ice cubes from freezing together due to defrost cycles. The auger is mainly used to move the ice cubes from the ice storage bin into the dispensing chute for dispensing. In addition, the ice dispenser may also include an ice crusher that crushes the ice cubes as they are being dispensed. The ice crusher uses a series of blades to chop or crush the ice cubes as the ice cubes are passing through the ice crusher. The auger and the ice crusher are known in the art. Therefore, they will not be discussed in detail here.

When an ice dispenser is installed in a refrigerator, it is desirable to minimize the volume occupied by the ice dispenser in order to maximize the usable storage volume of the refrigerator. One way to minimize the volume occupied by the ice dispenser is to shorten the length of the dispensing chute. However, a shortened dispensing chute may facilitate access to the auger and/or the blades of the ice crusher through the dispensing chute. In other words, a shortened dispensing chute may result in exposure of foreign objects inserted in the chute and reaching the auger and/or the blades of the ice crusher. If the foreign object is a user's hand, injury to the fingers is possible. Other types of foreign objects could cause damages to the auger and/or the blades of the ice crusher.

Hence, there is a need in the industry for a safety apparatus which stops or inactivates at least the operation of the auger and/or the ice crusher when it detects a foreign object such as a hand of a user in the dispensing chute.

### BRIEF DESCRIPTION OF THE INVENTION

As described herein, the preferred embodiments of the present invention overcome one or more of the above or other disadvantages known in the art.

One aspect of the present invention relates to an ice dispenser. The ice dispenser includes a bin for storing ice to be dispensed; a chute in communication with the bin; a device for at least one of crushing the ice and moving the ice from the bin to the chute; a controller for activating the device in response to a dispensing signal; and a safety apparatus configured to detect the presence of a foreign object in the chute and deactivate the device in response to such detection.

Another aspect of the present invention relates to a refrigerator. The refrigerator includes a compartment; a door for closing the compartment; and an ice dispenser disposed in the door. The ice dispenser includes a bin for storing ice to be dispensed; a chute in flow communication with the bin, the chute having an upper end terminating at the bin and a lower end accessible from a front side of the door; a device for at least one of crushing the ice and moving the ice from the bin to the chute; a dispensing switch for generating a dispensing signal; a controller for activating the device in response to the dispensing signal; and a safety apparatus configured to detect the presence of a foreign object in the chute, and to provide an indication responsive to the detected presence to the controller. The controller deactivates the device once receiving the indication.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 illustrates a perspective view of an exemplary refrigerator having an ice dispenser;

FIG. 2A illustrates a front view of the exemplary refrigerator of FIG. 1; FIG. 2B is a partial cross-sectional top view, schematically showing the ice storage bin, the auger and the ice crusher of the refrigerator of FIG. 2A;

FIG. 3 illustrates a partial, cross-section view of the ice dispenser of FIG. 1;

FIG. 4 illustrates a safety device in accordance with a first embodiment of the invention;

FIG. 5 illustrates a safety device in accordance with a second embodiment of the invention;

FIG. 6 illustrates a safety device in accordance with a third embodiment of the invention;

FIG. 7 illustrates a safety device in accordance with a fourth embodiment of the invention; and

FIG. 8 illustrates a safety device in accordance with a fifth embodiment of the invention.

It is to be understood that the figures and descriptions of the preferred embodiments of the present invention have been simplified to illustrate elements that are relevant for a clear understanding of the present invention, while eliminating, for the purpose of clarity many other elements found in conventional systems of the type described herein. Those of ordinary skill of the art may recognize that other elements and/or steps are desirable and/or required in implementing the present invention. However, because such elements and steps are well known in the art, and because they do not facilitate a better understanding of the present invention, a discussion of such elements and steps is not provided herein.

### DETAILED DESCRIPTION OF THE PREFERRED EMBODIMENTS OF THE INVENTION

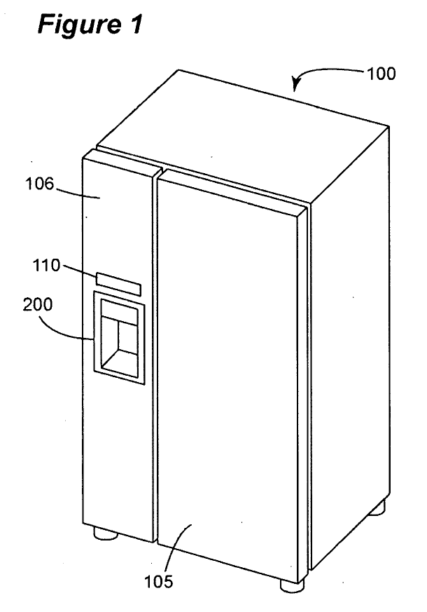

FIG. 1 illustrates an exemplary side-by-side refrigerator 100. The refrigerator 100 includes a fresh food compartment, which is covered by a door 105, and a freezer compartment, which is covered by a door 106. Within the door 106 is an ice dispenser 200 that may dispense stored ice cubes or crushed ice in response to a dispensing signal. The door 106 may include an area 110 above the ice dispenser 200 where a display, such as a Liquid Crystal Display (LCD) or Light Emitting Diode (LED) information center or, even, a television screen can be placed.

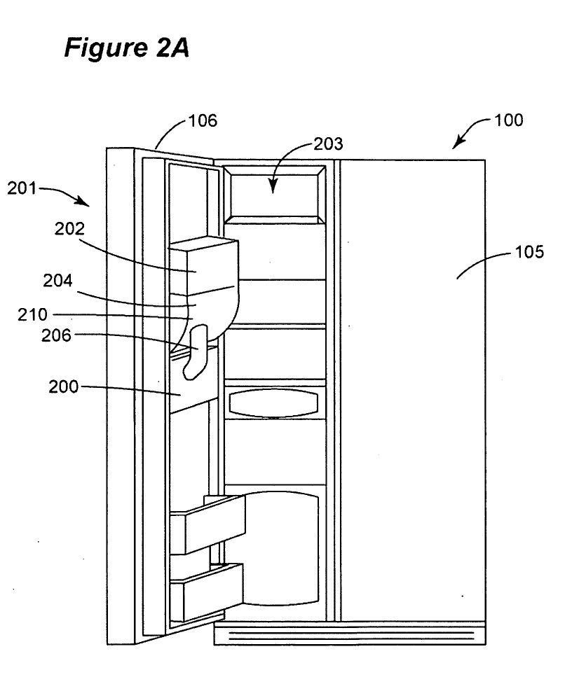

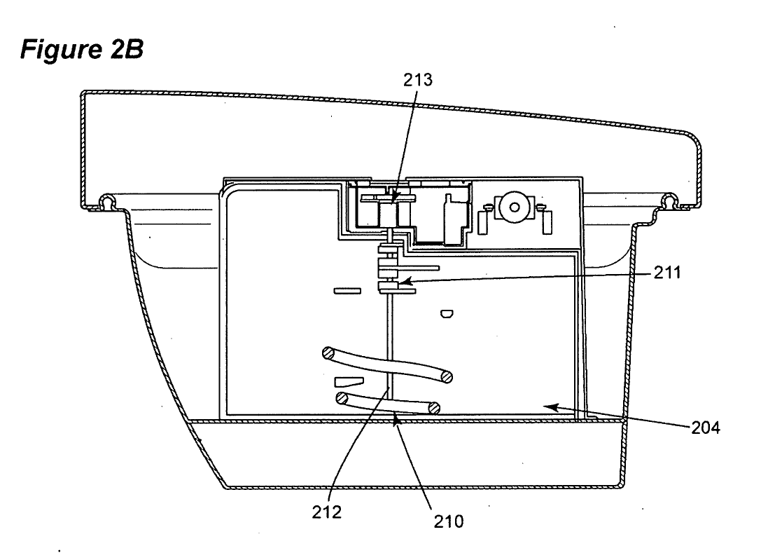

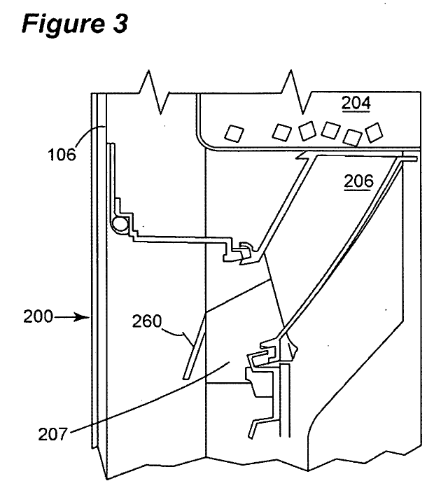

FIG. 2A illustrates a front view of the refrigerator 100 with the door 106 being in an open position to expose the freezer compartment 203 and an icemaker 201 mounted on the door 106. The icemaker 201 includes an ice forming or making apparatus 202. An ice storage bin 204 is disposed on the door 106, below and in flow communication with the ice making apparatus 202. A dispensing chute 206 extends from the ice storage bin 204 to an outlet 207 (see FIG. 3; the outlet 207 is known as a funnel in the art) exposed from the front side of the door 106 under which a cup or other receptacle may be placed.

Although the invention herein is described with regard to a side-by-side refrigerator, the ice dispenser 200 is not limited to use in any particular type of refrigerator or one particular compartment, but rather can be used in various types of refrigerators in which the fresh food and freezer compartments are disposed in a variety of positions relative to one another. It is further understood that the refrigerator in which the ice dispenser 200 is disposed is not required to have one or only one of each of the fresh food and freezer compartments, but rather can include none, or one or more of each of the fresh food and freezer compartments. By way of non-limiting examples, the ice dispenser 200 can be disposed in a refrigerator that includes one or more fresh food compartments and no freezer compartment, or that includes one or more freezer compartments and no fresh food compartment. Still further, it is understood that the ice dispenser 200 is not limited to use in a refrigerator, but rather can be disposed in various environments where one or more advantages of the ice dispenser 200 are provided, or used as a stand-alone unit.

A door 260 is provided proximate the exit end of the dispensing chute 206 for closing a flow from, or access to, the dispensing chute 206. The door 260 may either be spring loaded or electrically activated when a user requests ice. In this way, the door 260 is moved to an open position to permit ice or ice cubes to flow down from the dispensing chute 206.

As shown in FIG. 2B, an auger 210 and an ice crusher 211 are arranged or disposed in the ice storage bin 204. Each of the auger 210 and the ice crusher 211 is attached to a shaft 212 of a drive such as an electric motor 213. As is known in the art, the auger 210 and the ice crusher 211 can be driven by different electric motors 213. Also as is known in the art, the ice crusher 211 can be positioned downstream of the auger 210, or vice versa. Moreover, just one of the auger 210 and the ice crusher 211 can be employed. The auger 210, the ice crusher 211 and their interrelationship (if both are employed) are well known in the art, and therefore will not be discussed in detail here. Further, it is to be understood that while the embodiments illustrated herein employ an arrangement in which the ice storage bin 204, the auger 210 and the ice crusher 211 are on the door 106, the safety apparatus could be embodiment in any arrangement in which the ice crusher 211 or the auger 210 is positioned proximate the inlet end of the dispensing chute 206. For example, the ice storage bin 204, the auger 210 and the ice crusher 211 could be mounted in the interior of the freezer compartment and proximate the inlet end of the dispensing chute 206 when the door 106 is closed.

To further limit access to the ice storage bin 204, the dispensing chute 206 may be curved between the ice storage bin 204 and the outlet 207 of the ice dispenser 200.

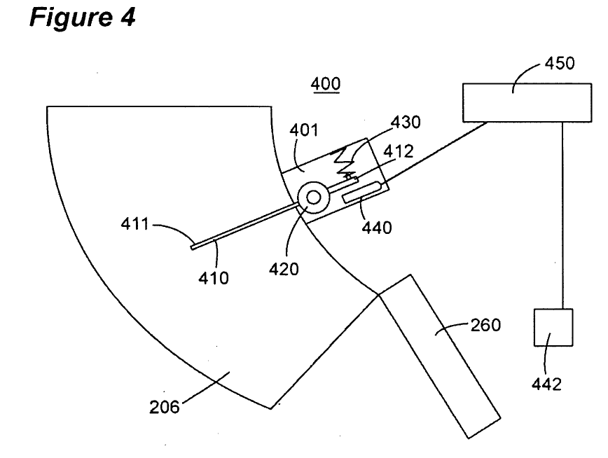

FIG. 4 illustrates a safety apparatus or device 400 in accordance with a first embodiment of the invention. As shown in FIG. 4, the dispensing chute 206 has a recess 401. The safety device 400 includes an actuator arm 410 that extends from the recess 401 into the dispensing chute 206.

More specifically, the actuator arm 410 is pivotably attached at a pivot point 420 to a wall defining the recess 401, and is thus able to rotate about the pivot point 420. The actuator arm 410 has a first end 411 disposed in the dispensing chute 206. The first end 411 has sufficient length in the chute 206 so that a hand in the chute 206 has to touch or engage the first end 411 before it can reach the auger or the ice crusher. The actuator arm 410 also has a second end 412 which is disposed in the recess 401 and in contact with an elastic element such as, for example, a spring 430. The spring 430 maintains the second end 412 (as well as the actuator arm 410) in a nominal position where the second end 412 does not engage a switch 440. The pivot point 420 is between the first and second ends 411, 412.

When the first end 411 of the actuator arm 410 is moved in an upward direction by a hand or other foreign object entering the dispensing chute 206, the spring 430 is stretched and the second end 412 of the actuator arm 410 moves away from the nominal position and engages and closes the switch 440. When closed, the switch 440 prevents, shuts off or deactivates the operation of the ice dispenser 200 (in this application, the expression “the operation of the ice dispenser” is used to refer to the operation of at least the auger when only the auger is used, the ice crusher when only the ice crusher is used, or at least one of the auger and the ice crusher when both are used). The switch 440 may be a normally open switch wherein contact by the second end 412 causes the switch 440 to close. In this closed position, a signal or indication may be sent to a controller such as a dispenser control board 450 which also receives a signal from the dispensing switch 442. Receipt of the signal from the switch 440 inhibits or overrides the dispensing signal even though the dispensing switch 442 is engaged or activated. Alternatively, the switch 440 and the dispenser switch 442 may be connected such that the opening or closing of the switch 440 prevents or stops the operation of the ice dispenser 200 by inhibiting the generation of the dispensing signal. For example, the switch 440 may be a normally closed switch, which under normal conditions would allow ice dispensing when the dispensing switch 442 is engaged. However, when the actuator arm 410 is forced upward by a hand moving toward the ice storage bin 204 so that the second end 412 engages the switch 440, the switch 440 is opened and the operation of the ice dispenser 200 is prevented or stopped even if the dispensing switch 442 is engaged. In either situation, the engagement of the switch 440 by the second end 412 of the actuator arm 410 overrides the position of the dispensing switch 442 and prevents or stops the operation of the ice dispenser 200. FIG. 4 shows that the switch 440 is connected to the dispenser control board 450. Of course, the switch 440 can be configured so that actuation of the switch 440 simply mechanically breaks the power circuit to the auger 210 or the ice crusher 211 directly or by energizing a relay which opens to break the power circuit.

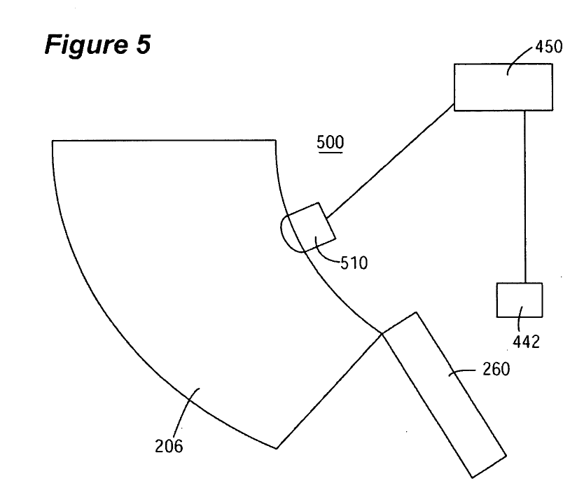

FIG. 5 illustrates a safety apparatus or device 500 in accordance with a second embodiment of the invention. The safety device 500 includes a temperature sensor such as an infrared temperature sensor 510 placed or positioned within the dispensing chute 206. In this embodiment, a signal may be provided to the dispenser control switchboard 450 along with a status signal provided by the dispensing switch 442. In this embodiment of the invention, the signal (an inhibiting signal) generated by the infrared temperature sensor 510 inhibits or overrides a dispensing signal when an object having a temperature warmer than or exceeding a threshold temperature is detected in the dispensing chute 206 by the infrared temperature sensor 510. As would be recognized and not shown, power signals may be provided to the infrared temperature sensor 510 from the dispenser control board 450.

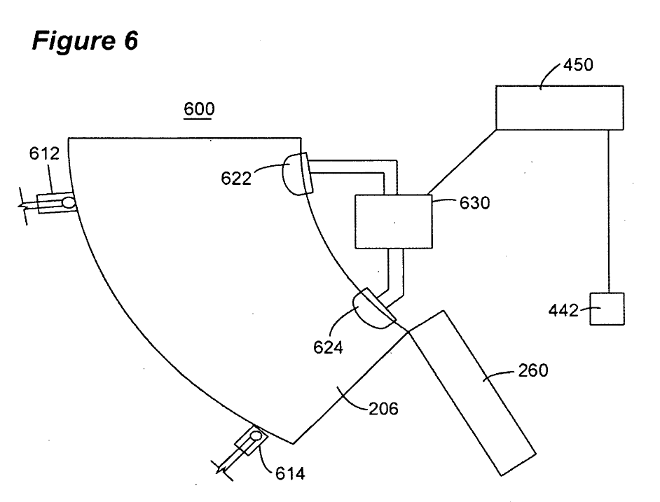

FIG. 6 illustrates a safety apparatus device 600 in accordance with a third embodiment of the invention. The safety device 600 includes spaced light sources 612, 614, such as light bulbs or LEDs, which are positioned in the dispensing chute 206. Corresponding spaced light detectors 622, 624 in the dispensing chute 206 receive light emitted by the light sources 612, 614. FIG. 6 shows the light sources 612, 614 on one side of the dispensing chute 206 and the light detectors 622, 624 on the other side of the dispensing chute 206. The light sources 612, 614 can be on different sides of the dispensing chute 206.

When the light beam from the light source 612, 614 is interrupted by a passing object, the respective light detector 622, 624 generates an interruption signal which is sent to a processor 630. The processor 630 analyzes the interruption signals received from the light detectors 622 and 624 to determine the cause of an interruption in the light beams between the light sources 612, 614 and the light detectors 622, 624. For example, a velocity of a passing object in the dispensing chute 206 may be determined by measuring a time difference between an interruption of a light beam from the light sources 612 and 614. A velocity which does not substantially match the velocity of falling ice or ice cubes indicates the presence of an object other than ice in the dispensing chute 206. In another example, the duration of an interruption of the light beams may be determined. In this case, when the duration of the interruption is measured over a short period that is substantially consistent with ice or ice cubes passing through ice chute 206, then the operation of ice dispensing continues. However, when a longer interruption is determined, then a presence of something other than ice or ice cubes is deemed to be within the dispensing chute 206 and a signal is provided to the dispenser control board 450 to inhibit or override the dispensing signal generated by the dispensing switch 442. Although, two examples of criterion for determining the presence of a foreign object in the dispensing chute 206 are disclosed, it would be within the knowledge of those skilled in the art to alter the criterion described and such alterations are considered to be within the scope of the invention recited herein. For example, when the order of light beam interruptions starts with the lower light source 614 being interrupted before the upper light source 612 is interrupted, the processor 630 concludes that a foreign object other than falling ice or ice cubes is present in the dispensing chute 206.

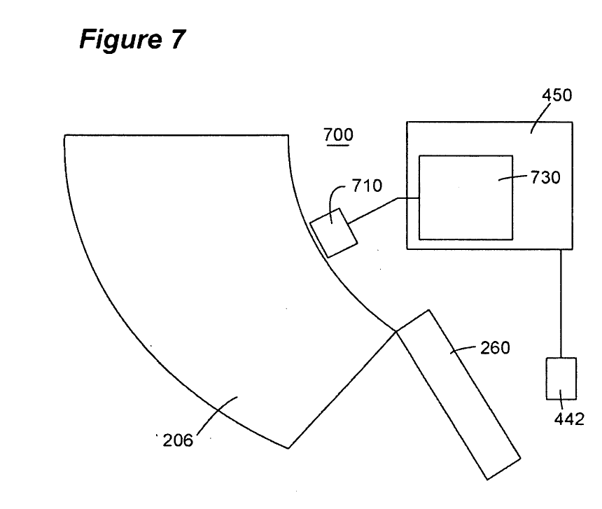

FIG. 7 illustrates a safety apparatus or device in accordance with a fourth embodiment of the invention. The safety device is in the form of a capacitive proximity sensor 700 which includes an capacitive proximity sensing element 710 located near or in the dispensing chute 206, and a processor 730 which is operatively connected to the capacitive proximity sensing element 710 and the dispenser control board 450. The capacitive proximity sensor 700 determines the presence of a hand, arm or other foreign body in the dispensing chute 206 and provides a signal to the dispenser control board 450 when the detected capacitance exceeds a capacitance threshold (each ice cube weights less than ½ ounce; a result, the capacitance of the ice cube is much lower than that of a human hand). The signal inhibits or overrides the dispensing signal, if any. The capacitive proximity sensor is known in the art, and therefore will not be discussed further here.

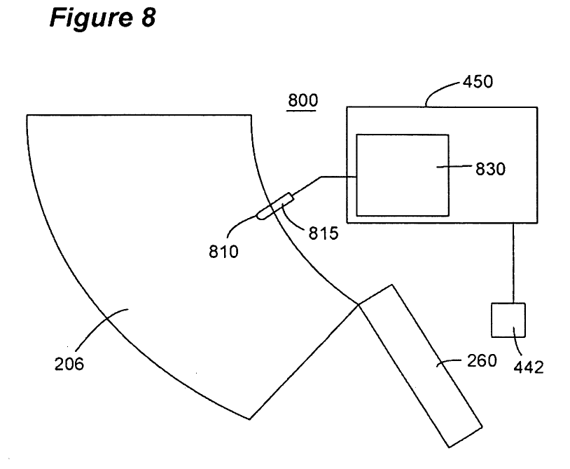

FIG. 8 illustrates a safety apparatus or device in accordance with a fifth embodiment of the invention. The safety device is in the form of a capacitance-sensing electrode sensor or capacitance touch switch 800. The capacitance-sensing electrode sensor 800 includes an electric contact or electrode 810 on or extending into the dispensing chute 206. The electric contact 810 is operatively connected to a capacitance sensing circuit 815 which is in turn operatively connected to a processor 830. The capacitance sensing circuit 815 and/or the processor 830 determine the presence of a hand, arm or other undesired object in the dispensing chute 206 when the object touches the electric contact 810 and the detected capacitance value exceeds a threshold value (each ice cube weights less than ½ ounce; a result, the capacitance of the ice cube is much lower than that of a human hand). The processor 830 then sends a signal to the dispenser control board 450 to inhibit or override the dispensing signal, if any, when an undesired foreign object is determined to be present in the dispensing chute 206. The capacitance-sensing electrode sensor is known in the art, and therefore will not be discussed further here.

In all of the embodiments discussed herein, the processor 630, 730, 830 may be made part of the dispenser control board 450 and interface with its existing circuitry.

Although not shown in detail, the dispenser control board 450 may include a determination circuit which monitors the inhibiting signal generated from each of the embodiments of the invention shown herein and prevents the activation of the ice dispensing mechanism even when the dispensing switch is engaged. In one aspect, the dispensing control board may employ an “AND” circuit that generates a dispenser activation signal when the dispensing switch and an inverted inhibit signal are present. Those skilled in the art would recognize other means to link the dispensing switch and the safety device and have been contemplated and are considered to be within the scope of the invention claimed herein. In another aspect, the dispenser control board may contain an application specific integrated circuit (ASIC) or other similar devices that receive signals from the dispensing switch and the safety device and generates or inhibits the generation of a dispensing signal based on the provided inputs.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. It is expressly intended that all combinations of those elements that perform substantially the same function in substantially the same way to achieve the same results are within the scope of the invention. Substitutions of elements from one described embodiment to another are also fully intended and contemplated.

What is claimed is:

1. An ice dispenser comprising:
a bin for storing ice to be dispensed;
a chute in communication with the bin;
a device for at least one of crushing the ice and moving the ice from the bin to the chute;
a controller for activating the device in response to a dispensing signal; and
a safety apparatus configured to detect a presence of a foreign object in the chute and deactivate the device in response to the detected presence.

2. The ice dispenser of claim 1, wherein the safety apparatus comprises a switch comprising an actuator arm having a first end extending into the chute and configured to detect the presence of the foreign object when the foreign object movingly engages the first end.

3. The ice dispenser of claim 2, wherein the switch is operative when actuated to deactivate the device.

4. An ice dispenser comprising:
a bin for storing ice to be dispensed;
a chute in communication with the bin;
a device for at least one of crushing the ice and moving the ice from the bin to the chute;
a controller for activating the device in response to a dispensing signal; and
a safety apparatus configured to detect a presence of a foreign object in the chute and to provide an indication responsive to the detected presence to the controller,
wherein the controller deactivates the device after receiving the indication.

5. The ice dispenser of claim 4, wherein the device comprises an ice crusher.

6. The ice dispenser of claim 4, wherein the device comprises an auger disposed in the bin.

7. The ice dispenser of claim 4, further comprising a dispensing switch for generating the dispensing signal, the controller activating the device after receiving the dispensing signal in the absence of the indication, the controller deactivating the device once receiving the indication.

8. The ice dispenser of claim 4, wherein the safety apparatus comprises a temperature sensor configured to detect a temperature in the chute, the object causing a temperature change in the chute when in the chute, the temperature sensor determining the presence of the object and providing the indication when the detected temperature exceeds a threshold.

9. The ice dispenser of claim 8, wherein the temperature sensor is disposed in the chute.

10. The ice dispenser of claim 9, wherein the temperature sensor comprises an infrared temperature sensor.

11. The ice dispenser of claim 4, wherein the safety apparatus comprises a capacitive proximity sensor configured to detect a capacitance in the chute, the object causing a capacitance change in the chute when in the chute, the capacitive proximity sensor determining the presence of the object in the chute and providing the indication when the detected capacitance exceeds a threshold.

12. The ice dispenser of claim 4, wherein the safety apparatus comprises a capacitance-sensing electrode sensor configured to detect a capacitance in the chute, the object causing a capacitance change in the chute when in the chute, the capacitance-sensing electrode sensor determining the presence of the object in the chute when the object contacts the capacitance-sensing electrode sensor, and providing the indication when the detected capacitance exceeds a threshold.

13. The ice dispenser of claim 12, wherein the capacitive proximity sensor comprises an electric contact in the chute and a capacitance sensing circuit operatively connected to the electric contact.

14. The ice dispenser of claim 4, wherein the safety apparatus comprises:
an actuator arm having a first end extending into the chute and a second end;
a switch disposed adjacent to the second end and configured to generate the indication when engaged by the second end;
an elastic element,
wherein the actuator arm is rotatable about a pivot point between the first end and the second end so that the second end is movable between a first position where the second end does not engage the switch and a second position where the second end engages the switch, and
wherein the elastic element urges the second end in the first position.

15. The ice dispenser of claim 14, wherein the safety apparatus determines the presence of the object when the object moves the first end so that the second end is moved from the first position to the second position.

16. The ice dispenser of claim 4, wherein the chute comprising two opposite sides, the safety apparatus comprising:
a first light source and a first light detector in the chute, one of the first light source and the first light detector being disposed on one of the sides, the other of the first light source and the first light detector being disposed on the other of the sides;
a second light source and a second light detector, one of the second light source and the second light detector being disposed on one of the sides, the other of the second light source and the second light detector being disposed on the other of the sides;
each of the first and second light detectors being configured to:
monitor a light generated by a respective light source, and
generate an interruption signal once the light is interrupted, and
a processor configured to process the generated interruption signals from the first light detector and the second light detector and to provide the indication when the interruption signals satisfy at least one known criterion.

17. The ice dispenser of claim 16, wherein the at least one known criterion comprises a time duration between the generated interruption signals.

18. The ice dispenser of claim 16, wherein the at least one known criterion comprises an order in which the generated interruption signals are generated.

19. The ice dispenser of claim 16, wherein the processor is made an integral part of the controller.

20. A refrigerator comprising:
a compartment;
a door for closing the compartment; and
an ice dispenser disposed in the door, the ice dispenser comprising:
a bin for storing ice to be dispensed;
a chute in flow communication with the bin, the chute having an upper end terminating at the bin and a lower end accessible from a front side of the door;
a device for at least one of crushing the ice and moving the ice from the bin to the chute;
a dispensing switch for generating a dispensing signal;
a controller for activating the device in response to the dispensing signal; and
a safety apparatus configured to detect a presence of a foreign object in the chute, and to provide an indication responsive to the detected presence to the controller,
wherein the controller deactivates the device once receiving the indication.

21. The refrigerator of claim 20, wherein the device comprises at least one of an ice crusher and an auger.
